(19) United States
(12) Patent Application Publication
(10) Pub. No.: US 2024/0266601 A1
(43) Pub. Date: Aug. 8, 2024

(54) COMPOSITION FOR PREPARING A GEL POLYMER ELECTROLYTE, GEL POLYMER ELECTROLYTE, AND LITHIUM-METAL SECONDARY BATTERY COMPRISING IT

(71) Applicant: REPSOL, S.A, Madrid (ES)

(72) Inventors: Juan NICOLÁS AGUADO, MÓSTOLES (ES); Francisco José ALÍA MORENO-ORTÍZ, MÓSTOLES (ES); Oihane GARCÍA CALVO, DONOSTIA-SANSEBASTIÁN (ES); Andriy KVASHA, DONOSTIA-SANSEBASTIÁN (ES); Elisabetta FEDELI, DONOSTIA-SANSEBASTIÁN (ES); Tho THIEU, DONOSTIA-SANSEBASTIÁN (ES); Izaskun COMBARRO PALACIOS, DONOSTIA-SANSEBASTIÁN (ES); Idoia URDAMPILLETA GONZALEZ, DONOSTIA-SANSEBASTIÁN (ES)

(21) Appl. No.: 18/580,124

(22) PCT Filed: Jul. 22, 2022
(86) PCT No.: PCT/EP2022/070614

§ 371 Date: Jan. 17, 2024

(30) Foreign Application Priority Data
Jul. 23, 2021 (EP) 21382673.8

(51) Int. Cl. H01M 10/0565; H01M 10/052

(52) U.S. Cl. CPC H01M 10/0565; H01M 10/052; H01M 2300/0025; H01M 2300/0085

(57) ABSTRACT

It is provided a composition for preparing a gel polymer electrolyte comprising a mixture of LiPF₆, LiTFSI, and LiDFOB; a solvent system comprising a fluorinated cyclic carbonate solvent and a linear carbonate solvent; a (meth)acrylate monomer; and a polymerization initiator. It is also provided a gel polymer electrolyte formed by in-situ polymerization of the composition, and a lithium-metal secondary battery comprising it.

This application claims the benefit of and priority to the European Patent Application EP21382673.8 filed on Jul. 23, 2021.

### TECHNICAL FIELD

The present invention relates to the field of rechargeable batteries. In particular, it relates to a composition for preparing a gel polymer electrolyte, to a gel polymer electrolyte formed by thermal in-situ polymerization of the composition, and to a lithium-metal secondary battery comprising the gel polymer electrolyte.

### BACKGROUND ART

Improving the cycle life and the safety of lithium metal batteries is a must especially for electric vehicle and eVTOL applications. On one side, common lithium metal batteries with liquid electrolyte present poor cyclability and safety due to the use of flammable liquid solvents and lithium dendrites formation provoking cell short circuiting and, as result, overheating followed by thermal runaway.

To this regard, the replacement of liquid electrolytes by solid electrolyte systems such as solid polymer electrolytes, solid inorganic electrolytes and composite hybrid electrolytes in great extent solves the safety and cyclability concerns. However, these systems are generally affected by different drawbacks. For example, polymer-based electrolytes possess lower ionic conductivity at room temperature and loss of the mechanical properties at the working temperature (>60° C.), while inorganic electrolytes are fragile and provide the poor and resistive interfacial contact between the electrodes and the electrolyte that affects the cell electrochemical performance.

In this context, gel polymer electrolytes (GPEs) represent a valid alternative merging the high ionic conductivity of liquid electrolytes with the improved safety of solid state systems. Furthermore, GPEs can be easily modified with a wide variety of additives to improve both safety and cyclability. As an instance, the document CN112018438A discloses a secondary battery wherein a gel electrolyte is obtained by in situ polymerization of a composition containing LiPF₆.

Although several GPE-based lithium batteries have been disclosed in the literature, there is still a need to improve the properties of GPEs in order to obtain lithium batteries, particularly of lithium-metal batteries, having an improved performance in terms of safety, discharge capacity, cyclability, and coulombic efficiency.

### SUMMARY OF INVENTION

The inventors have found a new gel polymer electrolyte comprising three specific lithium salts, a fluorinated cyclic carbonate, a linear carbonate, and a solid polyacrylic cross-linked network that allows improving the cyclability of lithium metal cells and lithium metal batteries. The solid-like electrolyte is achieved by thermal treatment of the liquid precursor directly inside a cell or battery. The synergy among all the GPE components leads to an improvement in the cell cyclability (6 times higher than in-situ formed gel polymer electrolyte prepared with conventional liquid electrolyte for Li-ion batteries) and in addition the coulombic efficiency is also improved.

Another important advantage of the in-situ polymerized gel polymer electrolyte of the invention is that it minimizes the leakage of liquid electrolyte in case of cell damage. Additionally, the GPE of the present invention allows increasing the compatibility with lithium metal anodes and different cathode materials (such as NMC622 and NMC811) while also allowing for adaptability to common lithium-ion battery manufacturing techniques and equipment (e.g., filling of the liquid precursor in the assembled dry cell). In addition, in-situ polymerization of a composition into a gel polymer electrolyte is a cost effective way to integrate GPE into a cell which does not require special equipment in comparison with conventional LIB production facilities.

Thus, a first aspect of the invention relates to a composition for preparing a gel polymer electrolyte, the composition comprising:
LiPF₆, LiTFSI, and LiDFOB as electrolyte salts;
a solvent system comprising a fluorinated cyclic carbonate solvent and a linear carbonate solvent;
a (meth)acrylate monomer; and
a polymerization initiator.

A second aspect of the invention relates to a gel polymer electrolyte formed by in-situ polymerization of the composition defined herein above and below, particularly by thermally initiated in-situ polymerization.

It is known that the in-situ polymerization technique allows a more efficient penetration of the liquid precursor into the porous electrodes and separator improving the interface contact between the electrolyte, the separator, the cathode, and the flat Li anode, and leading to an improved electrochemical performance in comparison with systems based on self-standing GPE. This effect is also foreseeable with gel polymer electrolytes based on liquid precursors with viscosity close to conventional liquid electrolytes, but it is not a priori expected in more viscous precursors such as the composition for preparing a gel polymer electrolyte of the invention.

A third aspect of the invention relates to a lithium-metal secondary battery comprising:
a positive electrode,
a negative electrode,
a separator interposed between the positive electrode and the negative electrode, and
the gel polymer electrolyte as defined herein above and below.

Surprisingly, as can be seen from the examples and comparative examples, batteries comprising the GPE as defined in the present disclosure show a surprisingly good electrochemical performance.

### BRIEF DESCRIPTION OF DRAWINGS

FIG. 1 shows the electrochemical performance of Li-NMC622 coin cells containing the reference liquid electrolyte (LE) (Comparative Example 1), or the LEs of Comparative Examples 1 to 6 (Table 2 of Example 2) in terms of discharge capacity (Q, mAh/g_{NMC}) VS. cycle number (N) (cycling conditions: 3.0-4.3V, 0.25C/1C, 100% Depth of Discharge (DOD), 60° C.).

FIG. 2 shows the electrochemical performance of Li-NMC622 coin cells obtained from a reference GPE composition (Comparative Example 1), the electrolyte compositions of Examples 1 to 4, or the electrolyte composition of Comparative Example 7 (Table 3 of Example 2) in terms of discharge capacity (Q, mAh/g_{NMC}) vs. cycle number (N) (cycling conditions of Table 1: 3.0-4.3V, 0.33C/0.33D, 100% DOD, 25° C.).

FIG. 3 shows the number of cycles (N) of Li-NMC622 coin cells obtained from a reference GPE composition (Comparative Example 1), the electrolyte compositions of Examples 1 to 4, or the electrolyte composition of Comparative Example 7 (Table 3 of Example 2) at 80% of discharge capacity retention (CR).

FIG. 4 shows the cyclability (>150 cycles, 0 cycles and 10 cycles) of three Li-NMC622 coin cells: one obtained from the electrolyte composition of Example 1 (G20_0), another obtained from the electrolyte composition of Comparative example 8 (containing only one Li salt, LiTFSI) and another one obtained from the electrolyte composition of Comparative Example 9 (containing only one the Li salt, LiPF₆).

FIG. 5 shows the cyclability (>150 cycles, 0 cycles and 10 cycles) of three Li-NMC622 coin cells: one obtained from the electrolyte composition of Example 1 (G20_0), another obtained from the electrolyte composition of Comparative example 10 (containing only two Li salts, LiPF₆ and LiTFSI) and another one obtained from the composition of Comparative Example 11 (containing only two Li salts, LiPF₆ and LiTFSI).

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

It is noted that, as used in this specification and the appended claims, the singular forms “a”, “an”, and “the” include plural referents unless the context clearly dictates otherwise.

All percentages used herein are by weight of the total composition, unless otherwise designated.

As mentioned above, a first aspect relates to a composition for preparing a gel polymer electrolyte, the composition comprising LiPF₆, LiTFSI, and LiDFOB as electrolyte salts; a solvent system comprising a fluorinated cyclic carbonate solvent and a linear carbonate solvent; a (meth)acrylate monomer; and a polymerization initiator. The term (meth)acrylate monomer should be understood as including both acrylate monomer and methacrylate monomer.

In an embodiment, the composition for preparing a gel polymer electrolyte consists of a mixture of LiPF₆, LiTFSI, and LiDFOB as electrolyte salts; a solvent system comprising a fluorinated cyclic carbonate solvent and a linear carbonate solvent; a (meth)acrylate monomer; and a polymerization initiator.

In another embodiment, optionally in combination with one or more features of the embodiments defined above, the composition for preparing a gel polymer electrolyte has a total Li molarity from 0.8 to 1.5 M. Particularly, the composition comprising from 0.2 to 1.2 M of LiPF₆, from 0.2 to 1.2 M of LiTFSI, and from 0.1 to 0.5 M of LiDFOB.

In another embodiment, optionally in combination with one or more features of the embodiments defined above, the electrolyte salts LiTFSI:LiPF₆:LIDFOB are in a molar ratio of 1:1:1.

Thus, the composition for preparing a gel polymer electrolyte of the invention can contain a relatively high amount of LiDFOB, a lithium salt with a relatively low solubility in the organic solvents currently used in this technology.

In another embodiment, optionally in combination with one or more features of the particular embodiments defined above, the fluorinated cyclic carbonate solvent is selected from the group consisting of 4-fluoro-1,3-dioxolan-2-one (FEC; also known as fluoroethylene carbonate), cis-4,5-difluoro-1,3-dioxolan-2-one (cis-F₂EC), trans-4,5-difluoro-1,3-dioxolan-2-one (trans-F2EC), 4,4-difluoro-1,3-dioxolan-2-one (4,4-F₂EC), 4,4,5-trifluoro-1,3-dioxolan-2-one (F3EC), and mixtures thereof. In a more particular embodiment, the fluorinated cyclic carbonate solvent is FEC.

The fluorinated cyclic carbonate can be in an amount from 2 to 50 wt %, or from 5 to 40 wt %, or from 10 to 30 wt %, or from 20 wt %, with respect to the total amount of solvent system.

As shown in the examples, the composition for preparing a gel polymer electrolyte of the invention can contain a relatively high amount of fluorinated cyclic carbonate, particularly of FEC, compared with LEs and GPEs of the prior art, where fluorinated cyclic carbonates such as FEC are used as additives in relatively small amounts (that is in percentages lower than 10 wt % with respect to the total amount of solvent system). This relatively high amount of fluorinated cyclic carbonate allegedly may reduce the ability of the solvent mixture to solubilize the Li salts. Thus, although in certain battery technology, such as secondary lithium metal batteries, the presence of highly fluorinated solvents such as FEC may help the formation of a stable SEI layer, they are generally used as additives in a relatively small amount (<10 wt %).

Conversely, in the composition for a GPE of the present invention, the fluorinated cyclic carbonate such as FEC is used as co-solvent up to about 50 wt %. Additionally, this could potentially release a detrimental amount of HF.

Unexpectedly, the composition for the GPE of the present invention is completely homogeneous without non-solubilized precipitates and, thus, is easy to scale up. Additionally, it allows obtaining a lithium metal battery with an improved performance compared to one containing a GPE composition with a lower amount of FEC.

In another embodiment, optionally in combination with one or more features of the embodiments defined above, the linear carbonate solvent is selected from the group consisting of ethylene carbonate (EC), dimethyl carbonate (DMC), di-ethyl carbonate (DEC), and ethyl-methyl carbonate (EMC), and mixtures thereof. In a more particular embodiment, the linear carbonate solvent is a mixture of EC and EMC, more particularly, EMC.

The linear carbonate can be in an amount from 50 to 98 wt %, or from 60 to 95 wt %, or from 70 to 90 wt % such as of 80 wt %, with respect to the total amount of solvent system.

In another embodiment, optionally in combination with one or more features of the embodiments defined above, the (meth)acrylate monomer is selected from the group consisting of pentaerythritol tetracrylate (PETEA), trimethylolpropane tri(meth)acrylate, pentaerythritol triacrylate, trimethylolpropane ethoxylate triacrylate, 1,6-hexanediol di(meth)acrylate, 1,3-butanediol di(meth)acrylate, dipentaerythritol penta-/hexa-acrylate, di(trimethylolpropane) tetraacrylate, and mixtures thereof. In a more particular embodiment, the (meth)acrylate monomer is PETEA.

The (meth)acrylate monomer can be in an amount from 1 to 10 wt %, particularly from 2 to 5 wt %, based on the total weight of the composition.

In another embodiment, optionally in combination with one or more features of the embodiments defined above, the polymerization initiator is selected from the group consisting of an azo-based initiator and a peroxide initiator. In a more particular embodiment, the polymerization initiator is an azo-based initiator, particularly azobisisobutyronitrile (AIBN).

The polymerization initiator can be in an amount from 0.01 to 1.5 wt %, or from 0.02 to 1 wt %, or from 0.1 to 0.5 wt %, based on the total weight of the composition.

### Preparation of the Gel Polymer Electrolyte

First a GPE precursor, that is the composition for preparing a gel polymer electrolyte described above, is prepared by:
i) dissolving the Li salts in the solvent system to obtain a liquid electrolyte (LE) system;
ii) dissolving the (meth)acrylate monomer in LE system to obtain a mixture; and
iii) dissolving the initiator in mixture of step ii)

The GPE of the present invention can be obtained by polymerizing the composition for preparing a gel polymer electrolyte described above by a conventional method known to those skilled in the art. For example, the GPE of the present invention can be prepared by in situ polymerization of the composition defined above in the interior of an electrochemical device such as a coin cell or a pouch cell.

### Lithium-Metal Secondary Battery Containing a GPE

As mentioned above, a third aspect of the invention relates to a lithium-metal secondary battery comprising a positive electrode, a negative electrode, a separator interposed between the positive electrode and the negative electrode, and the gel polymer electrolyte as defined herein above.

The negative electrode can be a lithium metal or a lithium alloy (such as with Mg, Al, Sn, or a mixture thereof) anode for instance having a thickness from 2 to 100 μm, particularly from 25 to 85 μm. The positive cathode can be a LiNi_{0.6}Mn_{0.2}Co_{0.2}O₂ (NMC622), LiNi_{0.8}Mn_{0.1}Co_{0.1}O₂ (NMC811), LiNi_{0.33}Mn_{0.33}C_{0.33}O₂ (NMC111), LiFePO₄ (LFP), LiMnxFe₁₋ₓPO₄ (LMFP), LiNiₓMn₂₋ₓO₄ (LNMO), or LiNi_{0.96}Mn_{0.01}Co_{0.03}O₂ (Li-rich NMC) based cathode, particularly with a loading from 1.0 to 5.0 mAh/cm², particularly of 3.0 to 3.5 mAh/cm², and a density from 2.5 to 3.8 g/cm³; particularly of 3.0 to 3.5 g/cm³; and the separator can be a microporous separator such as a battery grade ceramic coated porous separator.

The GPE preparation method comprises:
i) arranging a positive electrode, a negative electrode, and a separator interposed between the positive electrode and the negative electrode together to form an electrode assembly;
ii) injecting the composition for preparing a gel polymer electrolyte of the present invention into the electrode assembly; and
iii) in situ polymerizing the polymer to form the gel polymer electrolyte.

In-situ polymerization can be carried out by thermally initiated polymerization. The polymerization time is usually 0.1 to 24 hours, such as from 4 to 8 hours. The polymerization can be carried out at a temperature from about 50° C. to 90° C. such as 70° C.

The GPE obtainable by the process mentioned above also forms part of the invention.

A lithium metal secondary battery can be obtained by assembling a negative electrode and a positive electrode with a separator interposed therebetween, putting the assembly in a battery container, injecting the composition for preparing a gel polymer electrolyte of the invention into the battery container, sealing the battery container, and carrying out the in-situ polymerization in order to polymerize the electrolyte composition.

The lithium metal secondary battery obtainable by the process mentioned above also forms part of the invention.

Throughout the description and claims the word “comprise” and variations of the word, are not intended to exclude other technical features, additives, components, or steps. Furthermore, the word “comprise” encompasses the case of “consisting of”.

The following examples and drawings are provided by way of illustration, and they are not intended to be limiting of the present invention. Furthermore, the present invention covers all possible combinations of particular and preferred embodiments described herein.

### EXAMPLES

### Example 1. GPE and preparation of a coin cell

### A) Materials for GPE Preparation

Battery grade lithium hexafluorophosphate (LiPF₆) and lithium bis(trifluoromethanesulfonyl)imide (LiTFSI) salts were purchased from Solvionic (France), and lithium difluoro(oxalato)borate (LiDFOB) was purchased from Merck. All these battery grade materials possess low water content (<20 ppm). Nonetheless, LiDFOB and LiTFSI were further dried at 110° C. for 24 h before use. Battery grade EMC and FEC carbonate solvents were also purchased from Solvionic (France) and used without neither further purification nor drying. Polymer precursor pentaerythritol tetracrylate (PETEA) and initiator 2,2′-azobis(2-methylpropionitrile) (AIBN) were used as received.

### B) GPE Precursor Preparation

The following process was followed to prepare the composition (precursor, i.e. before polymerization) for the GPE of Example 1 (herein called “G20_0”):

1M of LiTFSI, LIDFOB and LiPF₆ (1:1:1 mol) are dissolved in EMC:FEC (7:3 vol). PETEA (1.5 wt %) and AIBN (0.1 wt %) are added as cross-linking system. This G20_0 precursor solution was prepared in dry room (dew point −50° C.) at 20° C. by magnetic stirring (VELP Scientifica, Spain). The mixture was stored in a closed amber vial to avoid solvent evaporation and/or premature cross-linking of the acrylate monomer, before using to fill a pre-assembled coin cell (2025, Hohsen, Japan).

### C) Coin Cell Materials and Preparation

A positive electrode based on 96 wt % of a commercial lithium nickel manganese cobalt oxide powder (NMC622), 2 wt % of carbon black C45 (Imerys, Switzerland), and 2 wt % of polyvinylidene fluoride binder Solef 5130 (Solvay, Italy) was prepared by slurry casting method on a commercial carbon coated aluminum current collector. The positive electrode with a loading of 3.3 mAh·cm⁻² and density of 3.0 g·cm⁻³ was designed to maximize the cell energy density. The positive electrode disc with diameter (Ø) 16.60 mm was dried in a vacuum oven (Memmert, VO400) at 120° C. for 16 hours before cell assembling.

A lithium metal disc with Ø18.20 mm and thickness 50 μm (Albemarle, USA) was used as a counter electrode.

One disc of a battery grade ceramic coated porous separator with Ø18.92 mm was utilized to avoid direct short circuit during cell assembly until in-situ polymerization of the gel electrolyte precursor is performed.

A coin cell composed of the lithium metal anode, the NMC622 based cathode, and the ceramic coated microporous polyolefin separator described above was filled with 50 μL of the GPE precursor described in section B) above. Then, the cell was closed with a crimper (HSACC-D2025, Hohsen, Japan) and heated up to 70° C./vacuum for 6 h (VD053-230V, Binder) to achieve a solid-like gel polymer electrolyte-based cell.

For each electrolyte sample tested (see Tables 2 and 3 below) at least 3 equivalent coin cells were always assembled to ensure reproducibility.

In order to develop the liquid electrolyte used in the GPE of the present invention, the influence of the following two factors was studied:
a) different Li salts mixtures, and
b) different solvents mixtures.

Comparative Examples 1 to 6.—Cell Performance with Liquid Electrolytes Containing Different Li Salts Mixtures

Even if the studied materials were gel polymer electrolytes, liquid fraction still represents the predominant part in the reference composition. For this reason, the development of a high performance electrolyte should address the improvement of its liquid fraction.

A commercial liquid electrolyte purchased from Solvionic composed by 1M LiPF₆ in EC:EMC:DMC (1:1:1 vol) was used as reference.

Table 1 gathers some liquid electrolyte (LE) compositions firstly developed to study the influence of different Li salt mixtures.

TABLE 1

| | | Molar | | | Volume |
|---|---|---|---|---|---|
| LE sample | Salt(s) | ratio | M | Solvents | ratio |
| Comp. Ex. 1 | LiPF₆ | — | 1 | EC:EMC:DMC | 1:1:1 |
| (reference) | | | | | |
| Comp. Ex. 2 | LiTFSI | — | 1 | EC:EMC:DMC | 1:1:1 |
| Comp. Ex. 3 | LiTFSI:LiPF₆ | 1:1 | 1 | EC:EMC:DMC | 1:1:1 |
| Comp. Ex. 4 | LiTFSI:LiDFOB | 1:1 | 1 | EC:EMC:DMC | 1:1:1 |
| Comp. Ex. 5 | LiTFSI:LiPF₆:LiDFOB | 1:1:1 | 1 | EC:EMC:DMC | 1:1:1 |
| Comp. Ex. 6 | LiPF₆:LiDFOB | 1:1 | 1 | EC:EMC:DMC | 1:1:1 |

EC: ethylene carbonate; DMC: dimethyl carbonate; EMC: ethyl methyl carbonate

Coin cells were prepared with the liquid electrolyte formulations shown in Table 2, including a reference example with the commercial liquid electrolyte of Solvionic. The coin cells were prepared similarly as explained in Example 1 except that no monomer and initiator were added and no in-situ polymerization was carried out.

Coin cells with the electrolyte of Comparative Examples 1 to 6 were cycled in a cell test system (CTS, Basytec GmbH) at 60±1° C. applying the protocol detailed in Table 2 below (simplified as 0.25C/1C, 3.0-4.3V, 100% DOD, 60° C.).

TABLE 2

| Stage | Mode | Conditions | Cycles |
|---|---|---|---|
| Charge | CC-CV | CC: current 0.25 C, voltage cut-off | Until 80% |
| | | 4.3 V CV: current cut off 0.1 C | of initial |
| Discharge | CC | CC: Current 1 C, voltage cut-off | discharge |
| | | 3.0 V | capacity |

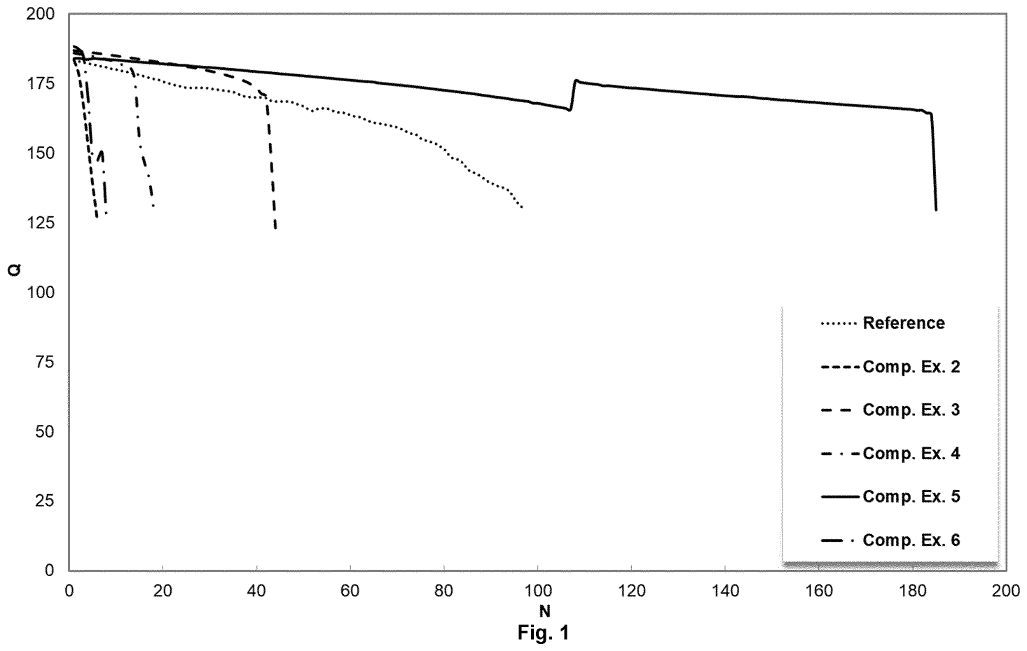

As shown in FIG. 1, a combination of three salts (LiTFSI:LiPF₆:LiDFOB) provided better results in terms of coin cell cyclability than electrolytes with two or only one Li salt, all dissolved in the same mixture of solvents (EC:EMC:DMC (1:1:1 vol)).

Examples 2 to 4 and Comparative Example 7.—Cell Performance with GPEs Containing Different Solvent Mixtures

In Table 3, several GPE formulations containing different solvent mixtures are shown.

TABLE 3

| | | Molar | | | Volume |
|---|---|---|---|---|---|
| GPE sample | Salt(s) | ratio | M | Solvents | ratio |
| Comp. Ex. 1 | LiPF₆ | — | 1 | EC:EMC:DMC | 1:1:1 |
| (reference) | | | | | |
| Comp. Ex. 7 | LiPF₆ | — | 1 | EC:EMC:FEC | 1:4:1 |
| Ex. 2 | LiTFSI:LiPF₆:LiDFOB | 1:1:1 | 1 | EC:EMC:FEC | 1:4:1 |
| Ex. 3 | LiTFSI:LiPF₆:LiDFOB | 1:1:1 | 1 | EMC:FEC | 9:1 |
| Ex. 4 | LiTFSI:LiPF₆:LiDFOB | 1:1:1 | 1 | EMC:FEC | 8:2 |
| Ex. 1 (G20_0) | LiTFSI:LiPF₆:LiDFOB | 1:1:1 | 1 | EMC:FEC | 7:3 |

EC: ethylene carbonate; DMC: dimethyl carbonate; EMC: ethyl methyl carbonate; FEC: fluoroethylene carbonate.

Coin cells were prepared with the electrolyte formulations of Table 3 by carrying out the process described in Example 1. That is, the electrolyte compositions were tested directly in GPE-based coin cells, after in-situ polymerization process.

Coin cells with the electrolyte of Examples 1, Examples 2 to 4, Comparative Example 1 (reference), and Comparative Example 7 were cycled in a cell test system (CTS, Basytec GmbH) at 25±1° C. applying the protocol detailed in Table 4 below (simplified as 0.33C-0.33C, 3.0-4.3V, 100% DOD, 25° C.).

TABLE 4

| Stage | Mode | Conditions | Cycles |
|---|---|---|---|
| Charge | CC-CV | CC: current 0.33 C, voltage | Until 80% |
| | | cut-off 4.3 V | of initial |
| | | CV: current cut off 0.1 C | |
| Discharge | CC | CC: Current 0.33 C, voltage | discharge |
| | | cut-off 3.0 V | capacity |

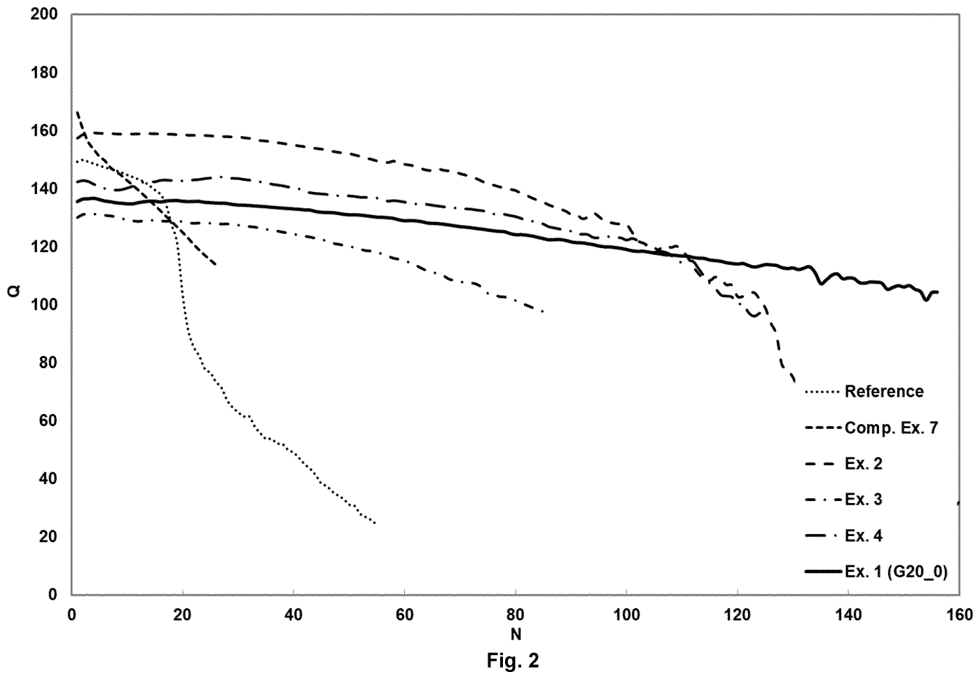

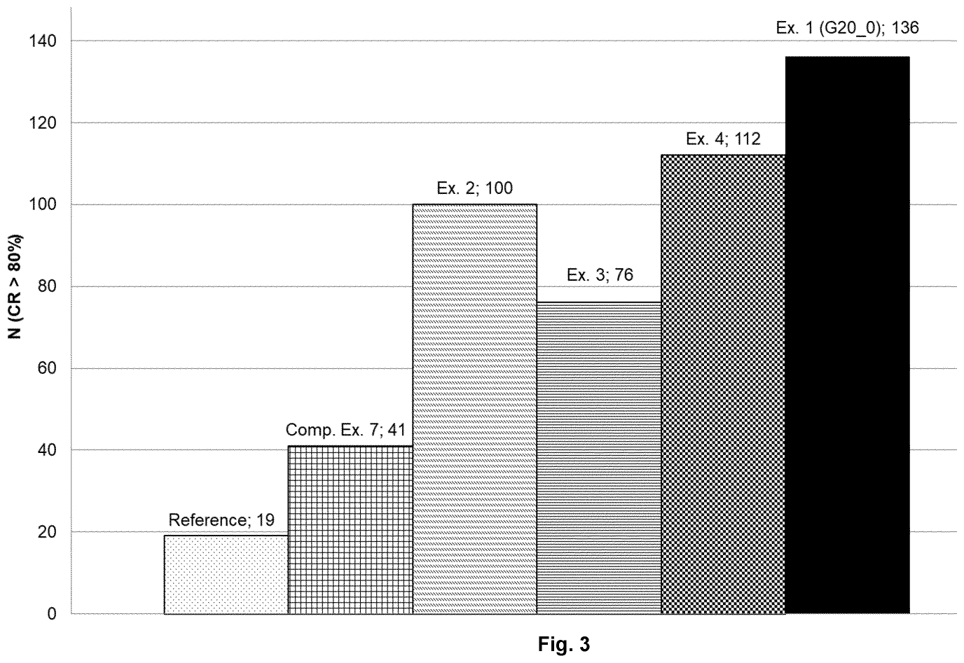

As shown in FIG. 2 and in FIG. 3, in the electrolyte composition of the examples of the invention a synergistic effect between the selected three salts and a solvent system comprising a fluorinated cyclic carbonate (FEC) and at least one linear carbonate (EMC, or EMC and EC; see electrolytes of Examples 1 to 4) is observed. This synergistic effect allows improving the electrochemical performance such as the cyclability of the coin cell (comprising an in-situ formed GPE) compared to different electrolyte compositions with one (Comparative examples 1, 2 and 7) or two salts (Comparative Examples 3, 4 and 6) and different mixture of solvents.

It has to be noticed that the electrolyte composition of Example 1 contains relatively high amount of LiDFOB salt, which is a compound with relatively low solubility in the organic solvents currently used in this technology. In fact, in the state of the art there are several examples in which LiDFOB (or similar low soluble Li salts) is used as additive (<5 wt %).

Furthermore, the electrolyte composition of Example 1 containing a high amount of FEC is completely homogeneous without non-solubilized precipitate.

To conclude, the synergy among all components in the in-situ formed GPE of the present invention leads to improved cyclability compared to the one of in-situ formed gel polymer electrolytes tested containing either one or two lithium salts and/or a different solvent system in lithium metal batteries.

### Comparative Examples 8 and 9

Cell coins were prepared from the two electrolyte compositions comprising one Li salt of Comparative Examples 8 and 9 shown in Table 5.

Cell testing conditions were: Li metal/GPE/NMC622; 0.33C-0.33C, 3.0-4.3V, 100% DOD, 25° C.

TABLE 5

| | Salt/s | Solvents | Monomer/s | Initiator | Cycles |
|---|---|---|---|---|---|
| GPE Sample | (M) | (vol.) | (wt %) | (wt %) | (CR > 80%) |
| Ex. 1 (G20_0) | 1M LiTFSI:LiPF₆:LiDFOB | EMC:FEC | PETEA | AIBN | 136 |
| | (1:1:1) | (7:3) | (1.5) | (0.1) | |
| Comp. Ex. 8 | 2.4M LiTFSI | EC:EMC (1:1) + | BA | AIBN | 0 |
| | | 2.4 wt % FEC | (61.0) | (1.2) | |
| Comp. Ex. 9 | 1M LiPF₆ | EC:EMC:DMC | TEGDA:BA | AIBN | 5 |
| | | (1:1:1) | 2:4 (6.0) | (1.0) | |

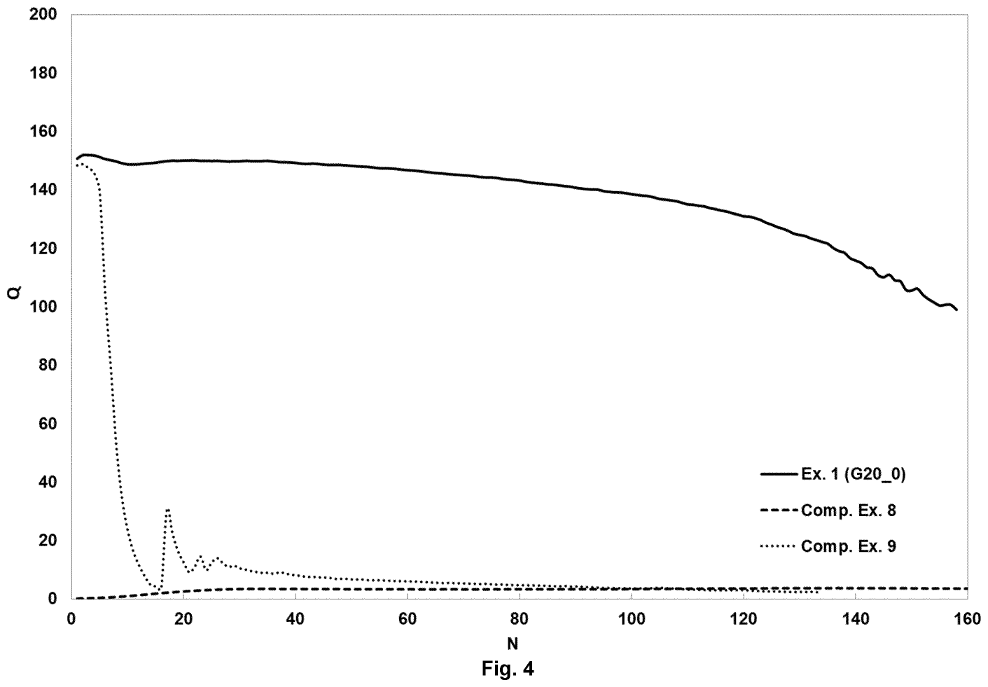

As can be seen in FIG. 4, the electrolyte composition of Example 1 (G20_0) provides a much better electrochemical performance in terms of combination of the initial discharge capacity, cyclability, and coulombic efficiency (>150 cycles, 0 cycles and 5 cycles) than the electrolyte compositions of Comparative example 8 and Comparative Example 9.

### Comparative Examples 10 and 11

Cell coins were prepared from the two electrolyte compositions comprising two Li salts of Comparative Examples 10 and 11 shown in Table 6.

Cell testing conditions were: Li metal/GPE/NMC622; 0.33C-0.33C, 3.0-4.3V, 100% DOD, 25° C.

TABLE 6

| | | | | | Cycles |
|---|---|---|---|---|---|
| Reference | Salts | Solvents | Monomer/s | Initiator | (CR > 80%) |
| Ex. 1 | LiPF₆:LiTFSI:LiDFOB | EMC:FEC | PETEA | AIBN | 136 |
| Comp. Ex. 10 | LiPF₆:LiTFSI | EC:EMC:DEC | PEGDA + ETPTA | AIBN | 4 |
| Comp. Ex. 11 | LiPF₆:LiTFSI | EC:EMC:DEC | PETEA | AIBN | 14 |

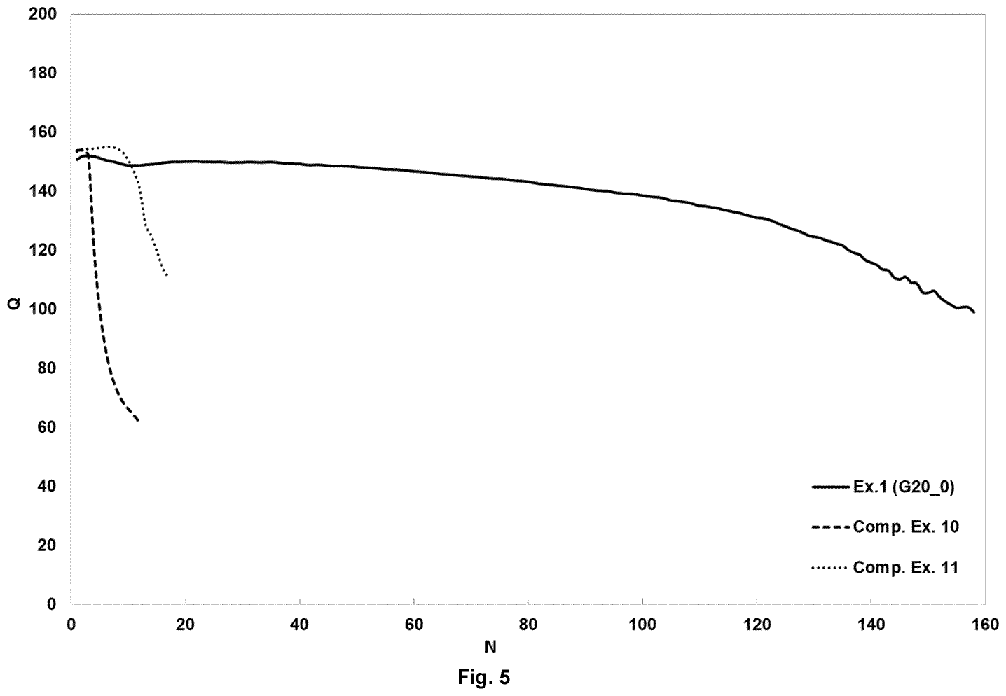

As can be seen in FIG. 5, the electrolyte composition of Example 1 (G20_0) provides a much better electrochemical performance in terms of cyclability and coulombic efficiency (>150 cycles, 4 cycles and 14 cycles) than the electrolyte compositions of Comparative example 10 and Comparative Example 11.

1. A composition for preparing a gel polymer electrolyte, the composition comprising:
LiPF₆, LiTFSI, and LiDFOB as electrolyte salts;
a solvent system comprising a fluorinated cyclic carbonate solvent and a linear carbonate solvent;
a (meth)acrylate monomer; and
a polymerization initiator.

2. The composition according to claim 1, having a total Li salt molarity of 0.8 to 1.5 M.

3. The composition according to claim 1, wherein the electrolyte salts are in the following amounts: from 0.2 to 1.2 M of LiPF₆, from 0.2 to 1.2 M of LiTFSI, and from 0.1 to 0.5 M of LiDFOB.

4. The composition according to claim 1, wherein the electrolyte salts LiTFSI:LiPF₆:LIDFOB are in a molar ratio of 1:1:1.

5. The composition according to claim 1, wherein the fluorinated cyclic carbonate solvent is selected from the group consisting of 4-fluoro-1,3-dioxolan-2-one (FEC), cis-4,5-difluoro-1,3-dioxolan-2-one (cis-F₂EC), trans-4,5-difluoro-1,3-dioxolan-2-one (trans-F₂EC), 4,4-difluoro-1,3-dioxolan-2-one (4,4-F₂EC), 4,4,5-trifluoro-1,3-dioxolan-2-one (F₃EC), and mixtures thereof.

6. The composition according to claim 1, wherein the fluorinated cyclic carbonate solvent is in an amount from 2 to 50 wt %, or from 5 to 40 wt %, or from 10 to 30 wt %, or of 20 wt %, with respect to the total amount of solvent system.

7. The composition according to claim 1, wherein the linear carbonate solvent is selected from the group consisting of, dimethyl carbonate (DMC), di-ethyl carbonate (DEC), ethyl-methyl carbonate (EMC), and mixtures thereof.

8. The composition according to claim 1, wherein the linear carbonate solvent is in an amount from 50 to 98 wt %, or from 60 to 95 wt %, or from 70 to 90 wt %, or of 80 wt %, with respect to the total amount of the solvent system.

9. The composition according to claim 1, wherein the (meth)acrylate monomer is selected from the group consisting of pentaerythritol tetracrylate (PETEA), trimethylolpropane tri(meth)acrylate, pentaerythritol triacrylate, trimethylolpropane ethoxylate triacrylate, 1,6-hexanediol di(meth)acrylate, 1,3-butanediol di(meth)acrylate, dipentaerythritol penta-/hexa-acrylate, di(trimethylolpropane) tetraacrylate, and mixtures thereof.

10. The composition according to claim 1, wherein the (meth)acrylate monomer is in an amount from 1 to 10 wt % or from 2 to 5 wt %, based on the total weight of the composition.

11. The composition according to claim 1, wherein the polymerization initiator is selected from the group consisting of an azo-based initiator and a peroxide initiator.

12. The composition according to claim 1, wherein the polymerization initiator is azobisisobutyronitrile (AIBN).

13. The composition according to claim 1, wherein the polymerization initiator is in an amount from 0.01 to 1.5 wt %, or from 0.02 to 1 wt %, or from 0.1 to 0.5 wt %, based on the total weight of the composition.

14. A gel polymer electrolyte formed by in-situ polymerization of the composition according to claim 1.

15. A lithium-metal secondary battery comprising:
a positive electrode,
a negative electrode,
a separator interposed between the positive electrode and the negative electrode, and
the gel polymer electrolyte of claim 14.

16. The composition according to claim 2, wherein the fluorinated cyclic carbonate solvent is in an amount from 2 to 50 wt %, or from 5 to 40 wt %, or from 10 to 30 wt %, or of 20 wt %, with respect to the total amount of the solvent system.

17. The composition according to claim 16, wherein the linear carbonate solvent is selected from the group consisting of dimethyl carbonate (DMC), di-ethyl carbonate (DEC), ethyl-methyl carbonate (EMC), and mixtures thereof; or a mixture of ethylene carbonate (EC) and EMC.

18. The composition according to claim 17, wherein the linear carbonate solvent is in an amount from 50 to 98 wt %, or from 60 to 95 wt %, or from 70 to 90 wt %, or of 80 wt %, with respect to the total amount of the solvent system.

19. The composition according to claim 18, wherein the (meth)acrylate monomer is selected from the group consisting of pentaerythritol tetracrylate (PETEA), trimethylolpropane tri(meth)acrylate, pentaerythritol triacrylate, trimethylolpropane ethoxylate triacrylate, 1,6-hexanediol di(meth)acrylate, 1,3-butanediol di(meth)acrylate, dipentaerythritol penta-/hexa-acrylate, di(trimethylolpropane) tetraacrylate, and mixtures thereof.

20. The composition according to claim 19, wherein the (meth)acrylate monomer is in an amount from 1 to 10 wt % or 2 to 5 wt %, based on the total weight of the composition.
